(19) United States
(12) Patent Application Publication
(10) Pub. No.: US 2004/0121747 A1
(43) Pub. Date: Jun. 24, 2004

(54) Kit of a local oscillator of an airborne VHF multimode communication transceiver

(76) Inventors: Sy-Kang Shen, Taipei (TW); Cheu-Ming Bow, Taipei (TW); Hong-Ji Chen, Taipei (TW); Lee-Tung Wei, Taipei (TW); Ying An Liu, Taipei (TW); Chiu-Chin Liao, Taipei (TW)

Correspondence Address: JOHNSON & ASSOCIATES PC, #282, 14625 BALTIMORE AVENUE, LAUREL, MD, 20707, US

(21) Appl. No.: 10/327,177

(22) Filed: Dec. 24, 2002

(51) Int. Cl. H04B 1/00

(52) U.S. Cl. 455/141

(57) ABSTRACT

The invention relates to a kit of a local oscillator of an airborne VHF multimode communication transceiver. The local oscillator of the airborne VHF multimode communication transceiver comprises a temperature compensated crystal local oscillator, a direct digital synthesizer (DDS) and an input/output interface.

### FIELD OF THE INVENTION

The present invention relates to a local oscillator of an airborne VHF multimode communication transceiver. More specifically to a local oscillator for use in the digital type airborne VHF multimode communication transceiver. The present invention of the local oscillator of airborne VHF multimode communication transceiver comprises a temperature compensated crystal local oscillator, a direct digital synthesizer (DDS) and an input/output interface to form a first and a second local oscillators of the airborne VHF multimode communication transceiver.

### BACKGROUND OF THE INVENTION

In general, relevant prior arts use Phase Lock Loop (PLL) circuit for building circuits of local oscillator for selecting channels of transceiver. Comparatively, PLL has flaws when adopted in VHF circuits due to production of large amount of noises. Thus it is not a good choice to use traditional PLL circuits in the digital type transceiver for modulation and demodulation. To perform modulation of airborne VHF multimode communication transceiver, the present invention adopts a D8PSK (Differentially encoded 8-Phase Shift Keyed) system. This is because the signal noise ratio for the D8PSK is set at very high standard thus complying with the requirements of digital type modulation. Therefore, there is a need to incorporate a DDS circuit to generate local oscillator signal to reduce the noise and distortion of the signal to as low as possible.

### SUMMARY OF THE INVENTION

In order to achieve the purpose mentioned above, one object of the present invention is to adopt a local oscillator of airborne VHF multimode communication transceiver comprising a temperature compensated crystal local oscillator, a direct digital synthesizer (DDS), an input/output interface to form a first and a second local oscillators of airborne VHF multimode communication transceiver.

Another object of the present invention is to adopt a temperature compensated crystal local oscillator to generate a second local oscillator signal for airborne VHF multimode communication transceiver.

Still, another feature of the present invention is to adopt a direct digital synthesizer (DDS) to output a first local oscillator signal for airborne VHF multimode communication transceiver.

A further object of the present invention is to adopt a temperature compensated crystal local oscillator to provide system clock signal for direct digital synthesizer (DDS) to generate first local oscillator signal.

The present invention will be readily apparent upon reading the following description of a preferred exemplified embodiment of the invention and upon reference to the accompanying drawings.

### BRIEF DESCRIPTION OF THE DRAWINGS

FIG. 1 is a block diagram of the prior art's local oscillator radio frequency

transceiver.

FIG. 2 is an I, Q vector analytical diagram showing D8PSK type demodulation of the prior art's local oscillator radio frequency transceiver.

FIG. 3 is a block diagram of the local oscillator of the airborne VHF multimode communication transceiver of the present invention.

FIG. 4 is an I, Q vector analytical diagram showing D8PSK type demodulation of the local oscillator of airborne VHF multimode communication transceiver of the present invention.

FIG. 5 and FIG. 6 are the detected output phase noise of the first local oscillator signal of the direct digital synthesizer (DDS) of the local oscillator of the airborne VHF multimode communication transceiver of the present invention.

### DETAILED DESCRIPTION AND PREFERRED EMBODIMENTS

The local oscillator of airborne VHF multimode communication transceiver system of the present invention is assembled by coupling a temperature compensated crystal oscillator, which generates a low noise second oscillator signal, to a digital type receiver's second mixer stage for demodulation, and also coupling said second oscillator signal to a direct digital synthesizer (DDS) for use as system clock signal. Meanwhile the second oscillator signal is also coupled to a digital type transmitter's first mixer stage for modulation, a direct digital synthesizer (DDS) via an input/output interface and an external microprocessor (not shown) control to generate a first local oscillator signal coupled to a digital type receiver's first mixer stage for demodulation and a digital type transmitter's second mixer stage for modulation respectively.

In a preferred embodiment of the present invention, the local oscillator of

airborne VHF multimode communication transceiver uses ANALOG

DEVICE AD985X, for example AD9852, to generate a first and a second

local oscillation frequency to effectively improve and resolve the noise problem associated with the prior art.

Also in a preferred embodiment of the present invention, the local oscillator of the airborne VHF multimode communication transceiver adopts the following: (1) temperature compensated crystal oscillator TCXO44.545 MHz for second local oscillator; (2) temperature compensated crystal oscillator TCX44.545 MHz for use as a system clock of direct digital synthesizer (DDS); (3) AD985X direct digital synthesizer (DDS) to generate a first local oscillator signal, and to apply sampling and waveform reproduction methods to improve the signal noise from −75 dbc/Hz@15 KHz to −105 dbc/Hz@15 KHz.

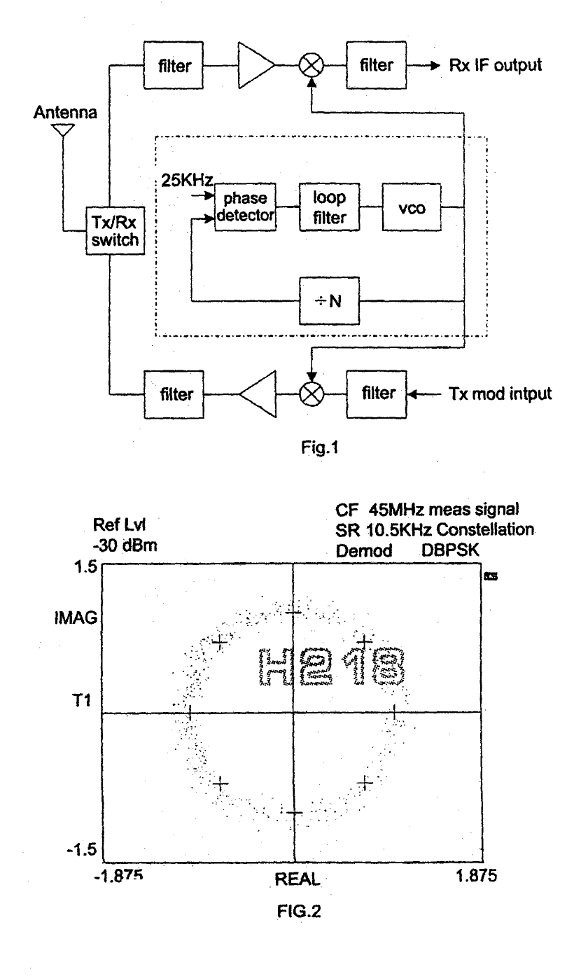

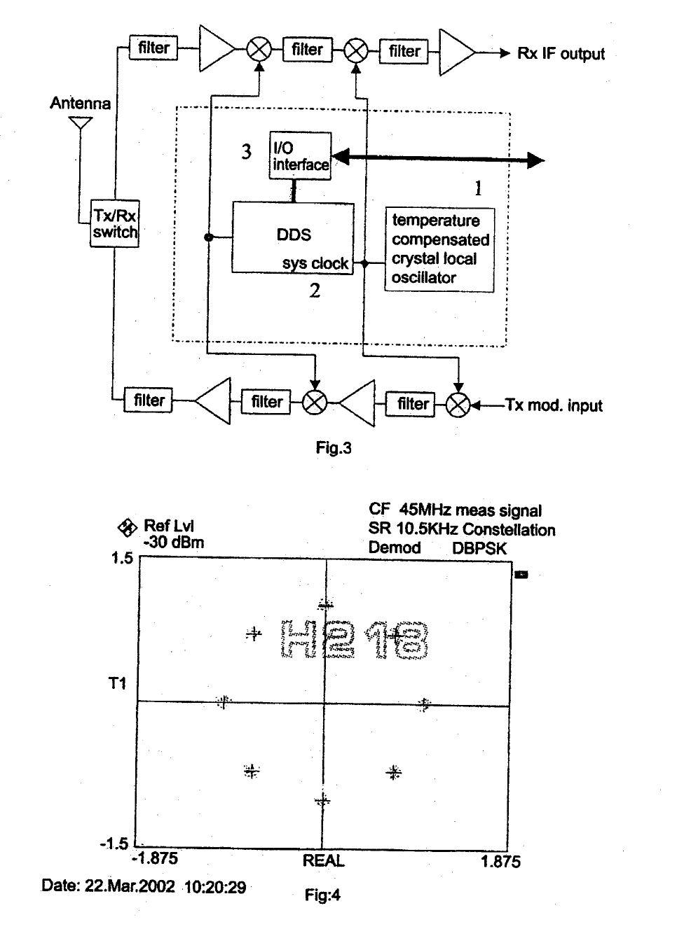

Referring to FIGS. 1-3, FIGS. 1 and 2 describe a block diagram and an I, Q vector analytical diagram showing D8PSK type demodulation of the local oscillator radio frequency transceiver of the prior art. FIG. 3 describes the local oscillator of the airborne VHF multimode communication transceiver of the present invention.

Referring to FIG. 3, the local oscillator of airborne VHF multimode communication transceiver system of the present invention is assembled by coupling a temperature compensated crystal oscillator 1, which generates a low noise second oscillator signal, to a digital type receiver's second mixer stage for demodulation, and also coupling said second oscillator signal to a direct digital synthesizer 2 (DDS) for use as system clock signal. Meanwhile the second oscillator signal is also coupled to a digital type transmitter's first mixer stage for modulation, a direct digital synthesizer 2 (DDS) via an input/output interface 3 and an external microprocessor (not shown) control to generate a first local oscillator signal coupled to a digital type receiver's first mixer stage for demodulation and a digital type transmitter's second mixer stage for modulation respectively.

FIG. 4 describes an I, Q vector analytical diagram showing D8PSK type demodulation of the local oscillator of the airborne VHF multimode communication transceiver of the present invention. The noise level shown is comparatively lower as compared to the I, Q vector analytical diagram showing D8PSK type demodulation of the local oscillator radio frequency transceiver of the prior art shown in FIG. 2.

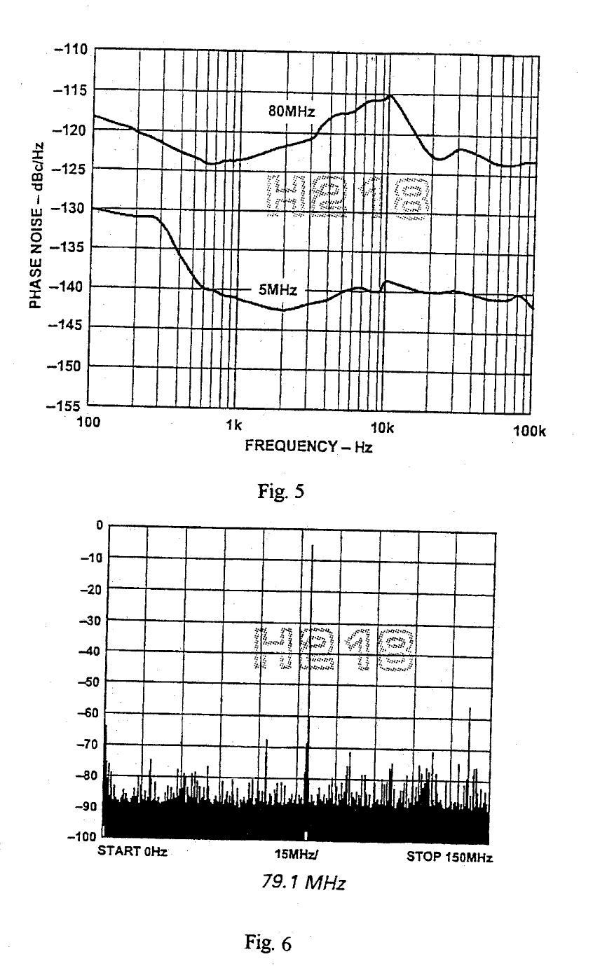

FIG. 5 and FIG. 6 describe the detected output phase noise of the first local oscillator signal of the direct digital synthesizer (DDS) of the local oscillator of the airborne VHF multimode communication transceiver of the present invention. Here the noise level is improved from −75 dbc/Hz@15 KHz of prior art to −105 dbc/Hz@15 KHz of the present invention.

From the above descriptions, it is understood that a local oscillator of the airborne VHF multimode communication transceiver of the present

invention is capable of improving the noise level, and in turn improves the quality of the airborne VHF multimode communication transceiver. Furthermore, because of its simple modular circuit and assembly, testing and maintenance are more simple than prior art. Thus the effectiveness and practicality of this product is very obvious.

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A local oscillator circuit assembly of airborne VHF multimode communication transceiver comprising a temperature compensated crystal local oscillator, a direct digital synthesizer (DDS) and an input/output interface.

2. The local oscillator circuit assembly in claim 1, wherein the local oscillator circuit assembly adopts a temperature compensated crystal local oscillator to generate the second local oscillator signal for the airborne VHF multimode communication transceiver.

3. The local oscillator circuit assembly as in claim 1, wherein the local oscillator circuit assembly adopts a direct digital synthesizer (DDS) to output the first local oscillator signal for airborne VHF multimode communication transceiver.

4. The local oscillator circuit assembly as in claim 1, wherein the local oscillator circuit assembly uses a temperature compensated crystal local oscillator to provide system clock signal for the direct digital synthesizer (DDS) to generate first local oscillator signal.

5. A system method for assembling a local oscillator circuit assembly of an airborne VHF multimode communication transceiver comprising the steps of:
(a) coupling a temperature compensated crystal oscillator, which generates a low noise second oscillator signal, to a digital type receiver's second mixer stage for demodulation;
(b) coupling said second oscillator signal to a direct digital synthesizer (DDS) for use as system clock signal; and
(c) Coupling the second oscillator to a digital type transmitter's first mixer stage for modulation, a direct digital synthesizer (DDS) via an input/output interface and an external microprocessor (not shown) control to generate a first local oscillator signal coupled to a digital type receiver's first mixer stage for demodulation and a digital type transmitter's second mixer stage for modulation respectively.
